(19) United States
(12) Patent Application Publication
(10) Pub. No.: US 2019/0146223 A1
(43) Pub. Date: May 16, 2019

(54) MULTIFOCAL DYNAMIC LENS FOR HEAD MOUNTED DISPLAY

(71) Applicant: Tuotuo Li, San Jose, CA (US)

(72) Inventor: Tuotuo Li, San Jose, CA (US)

(21) Appl. No.: 16/229,559

(22) Filed: Dec. 21, 2018

(51) Int. Cl. G02B 27/01; G09G 3/00

(52) U.S. Cl. CPC G02B 27/0172; G09G 3/001; G02B 2027/0127; G02B 2027/014; G02B 2027/0174

(57) ABSTRACT

Disclosed herein is a head mounted display including a projector to project multiple virtual images at different depth planes and an optical element to reflect the projected images to a viewpoint. A user can perceive the multiple virtual image at the different depth planes for realize a large field of view display without vergence accommodation conflict. The optical element can also transmit a view of the real world to provide an augmented reality experience.

### TECHNICAL FIELD

Embodiments herein generally relate to head mounted displays and in particular to augmented reality displays.

### BACKGROUND

Modern display technology may be implemented to provide head mounted displays (HMD). Such HMDs may be implemented to provide a view of both the real world and displayed digital content (images, videos, text, or the like). As such, a view of the real world can be augmented with the digital content. Such a display is often referred to as an augmented reality (AR) display. AR is useful for a variety of contexts, for example, defense, transportation, industrial, entertainment, wearable devices, or the like.

Conventionally, HMD systems have extremely difficult tradeoffs between various design and utility considerations, such as, for example, limited field of view and vergence accommodation conflict.

### BRIEF DESCRIPTION OF THE DRAWINGS

FIG. 1 illustrates an example head mounted display (HMD) system.

FIG. 2 illustrates an example lens of the HMD system of FIG. 1.

FIG. 3 illustrates a first example multi depth-plane projection system of the HMD system of FIG. 1.

FIG. 4 illustrates a second example multi depth-plane projection system of the HMD system of FIG. 1.

FIG. 5 illustrates a graph of a response of a dynamic focusing lens to changing optical power.

FIG. 6 illustrates the graph of FIG. 5 showing light transmitted through the dynamic focusing lens at periods during the response.

FIG. 7 illustrates example backlight masks and corresponding image slices.

FIG. 8 illustrates an example timing diagram.

FIG. 9 illustrates an example logic flow.

FIGS. 10A-10B illustrate a system to record an HOE of the HMD system of FIG. 1.

FIG. 11 illustrates an example computer readable medium.

FIG. 12 illustrates an example display system that can be implemented as part of the HMD system of FIG. 1.

### DETAILED DESCRIPTION

Various embodiments may be generally directed to head mounted displays (HMDs) and specifically to an HMD with a dynamically lens and a pattern generator arranged to cooperate to project digital content (also referred to as virtual images) at different depth planes. The content projected at these multiple depth planes (e.g., multiple depth plane images) can be projected onto a reflective optical element (e.g., a holographic optical element (HOE), or the like) to convey the multiple depth plane images to a viewpoint. As such, a wearer of the HMD may perceive the multiple depth plane images at the viewpoint. The HOE can be configured to transmit views of the real world to the viewpoint in conjunction with the multiple depth plane images. As such, an AR experience can be provided.

In some implementations, a digital micromirror device (DMD) may be provided to backlight an image (or images) displayed by a liquid crystal on silicon (LCOS) display to different depth planes. A dynamic lens (e.g., oscillating deformable lenses, or the like) can be arranged to focus the image at multiple depth planes, which may in turn be reflected by the HOE to a viewpoint. Thus, a viewer may perceive an image (or images) at multiple depths, thereby removing the depth discontinuity associated with vergence accommodation conflict. Furthermore, the presented image(s), or viewpoint, may have a large field of view (FOV).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, known structures and devices are shown in block diagram form in order to facilitate a description thereof. The intention is to provide a thorough description such that all modifications, equivalents, and alternatives within the scope of the claims are sufficiently described.

Additionally, reference may be made to variables, such as, “a”, “b”, “c”, which are used to denote components where more than one component may be implemented. It is important to note, that there need not necessarily be multiple components and further, where multiple components are implemented, they need not be identical. Instead, use of variables to reference components in the figures is done for convenience and clarity of presentation.

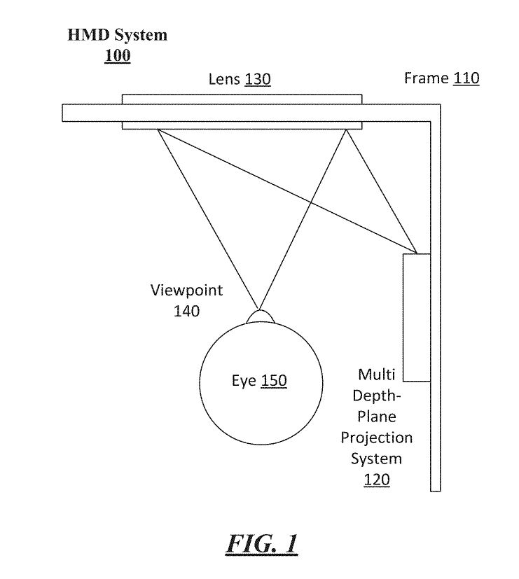

FIG. 1 illustrates an example of a portion of an HMD system 100 arranged according to the present disclosure. It is noted, that the device of this figure is depicted implemented as a pair of glasses. However, the system 100 may be embodied as a pair of glasses (e.g., as depicted), as a pair of binoculars, a monocular device (e.g., scope, or the like), as goggles, as a helmet, as a visor, as a wearable device, or the like. Embodiments are not limited in this context.

In general, the HMD system 100 is configured to provide an augmented reality (AR) image at viewpoint 140. As such, a wearer may perceive the AR image at viewpoint 140, for example, with eye 150. Said differently, the HMD system 100 may provide a virtual display in conjunction with a real-world view, which when combined at viewpoint 140 forms an AR image.

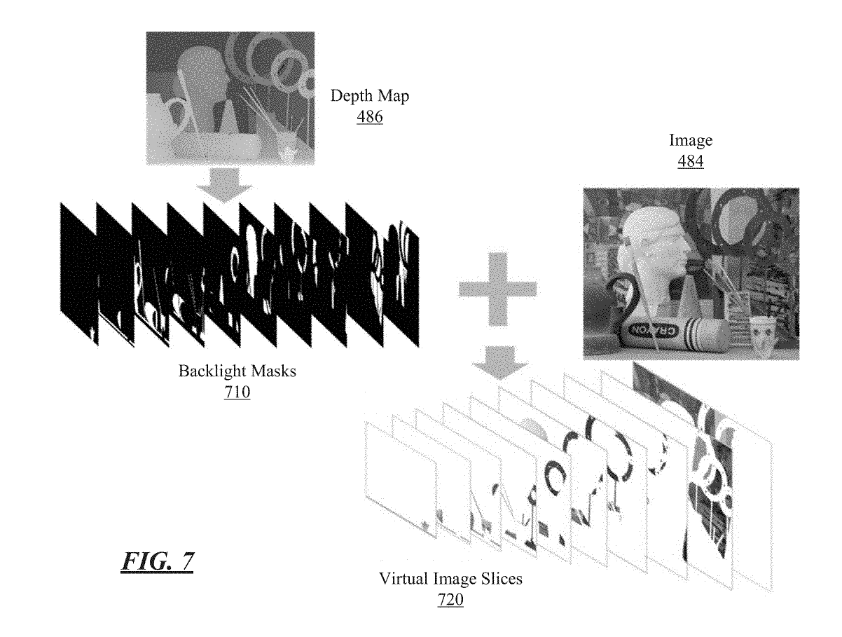

The HMD system 100 includes a frame 110, a multi depth-plane projection system 120, and lens 130. The multi depth-plane projection system 120 can be mounted to the frame 110. In general, multi depth-plane projection system 120 is arranged to project images focused at various depth planes (see FIG. 7). The images projected by the multi depth-plane projection system 120 are reflected by lens 130 to viewpoint 140. Furthermore, lens 130 is arranged to transmit a real-world view to viewpoint 140. Thus, the real-world view and the projected images can be combined to form an AR image.

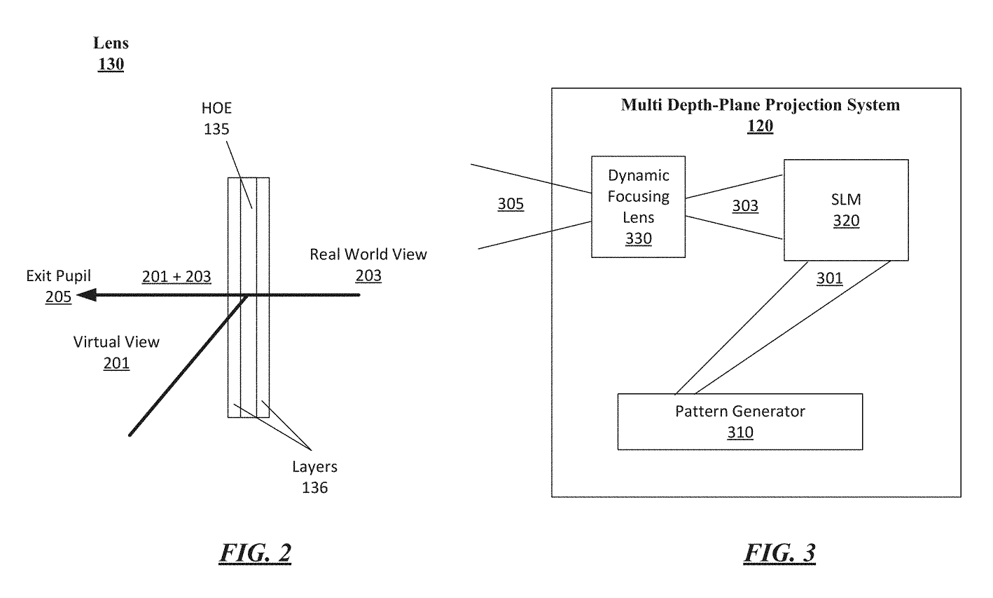

FIG. 2 illustrates an example lens 130. Lens 130 can comprise a holographic optical element (HOE) 135, or multipole HOEs 135, and lens layers 136. It is noted, that HOE 135 may sometimes be referred to as a holographic optical combiner. HOE 135 is arranged to reflect light incident from specific angles, directions, or sides (e.g., light from multi depth-plane projection system 120, or the like) or to reflect light based on the spectrum on the incident light, to an exit pupil (e.g., viewpoint 140, or the like). HOE 135 may be based on a variety of styles of optical elements. For example, HOE 135 may be a combiner lens (e.g., a holographic optical combiner lens, or the like) that reflects light (e.g., off-angle light, or the like) incident on a first surface while transmitting light incident on a second opposite surface. As depicted, lens 130, via HOE 135, can reflect (reflect and diffract, or the like) projected light 201 (e.g., light projected by multi depth-plane projector 120, or the like) to an exit pupil 205 and can transmit light 203 (e.g., light from the real world or environment) incident on a front side of the lens 130 to the exit pupil 205. As noted, projected light 201 may correspond to light projected by multi depth-plane projection system 120 while light 203 may correspond to light from the real world. Exit pupil 205 can correspond to viewpoint 140 from HMD system 100 of FIG. 1. Accordingly, a user may perceive an AR image (e.g., combined image from projected light 201 and real-world light 203) at exit pupil 205. It is noted, that although only a single exit pupil 205 is depicted, embodiments may be implemented to project an image to multiple exit pupils (e.g., based on a single input pupil or from multiple input pupils). Examples are not limited in this context.

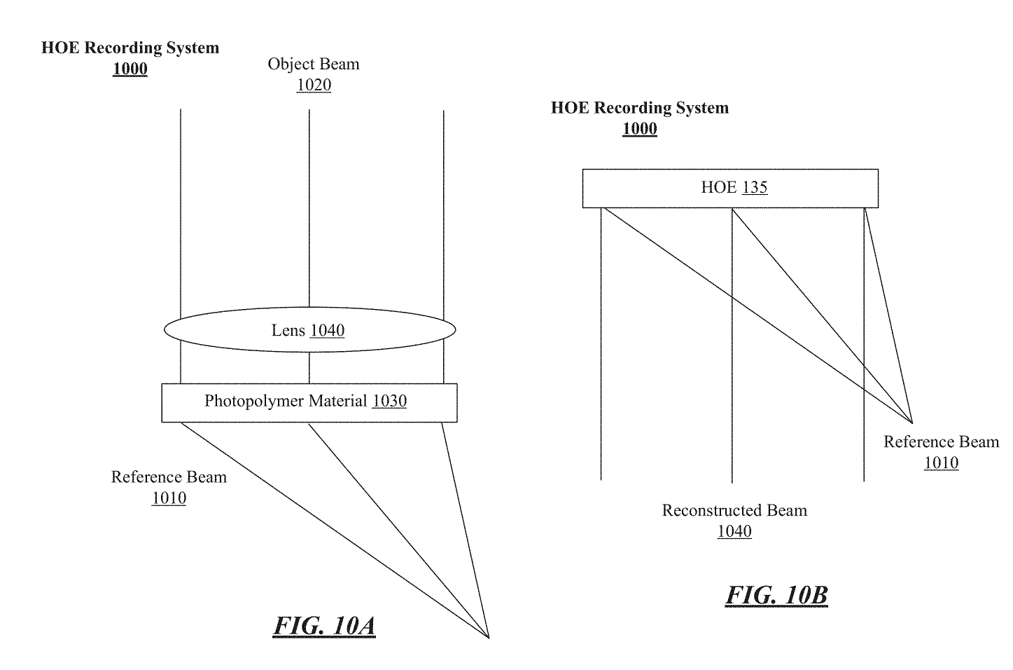

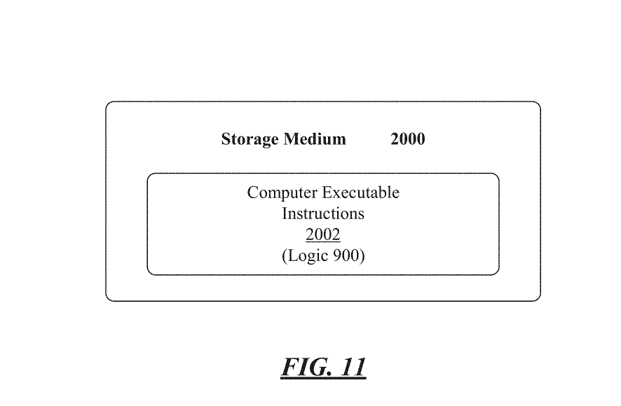

In general, HOE 135 may be manufactured by any of variety of manufacturing techniques, such as, for example, recording a hologram into a medium. However, an example manufacturing technique and system are described below in conjunction with FIGS. 10-11.

FIG. 3 illustrates an example multi depth-plane projection system 120, arranged according to some implementations. As depicted, multi depth-plane projection system 120 includes a pattern generator 310, a spatial light modulator (SLM) 320, and a dynamic focusing lens 330. In general, pattern generator 310 is arranged to generate patterns to selectively illuminate portions of an image projected by SLM 320. That is, pattern generator 310 can generate a number of binary patterns to illuminate or backlight SLM 320 to project portions of an image based on the binary pattern. For example, pattern generator 310 can generate a number of binary patterns at a first frequency while SLM 320 projects an image at a second frequency, which is lower than the first frequency. Thus, patterns generated by pattern generator 310 can selectively illuminate portions of SLM 320 to project selected portions of an image. These selected portions of the image (or partial images) can be focused at different depth planes via dynamic focusing lens 330.

As depicted, light 301 corresponding to patterns generated by pattern generator 310 is relayed to SLM 320 to backlight portions of SLM 320 to project light 303 corresponding to partial images. Light 303 is relayed to dynamic focusing lens 330 which focuses the partial images at different depth planes and relays light 305, corresponding to focused partial images, to HOE (e.g., HOE 135 of lens 130 of FIG. 1).

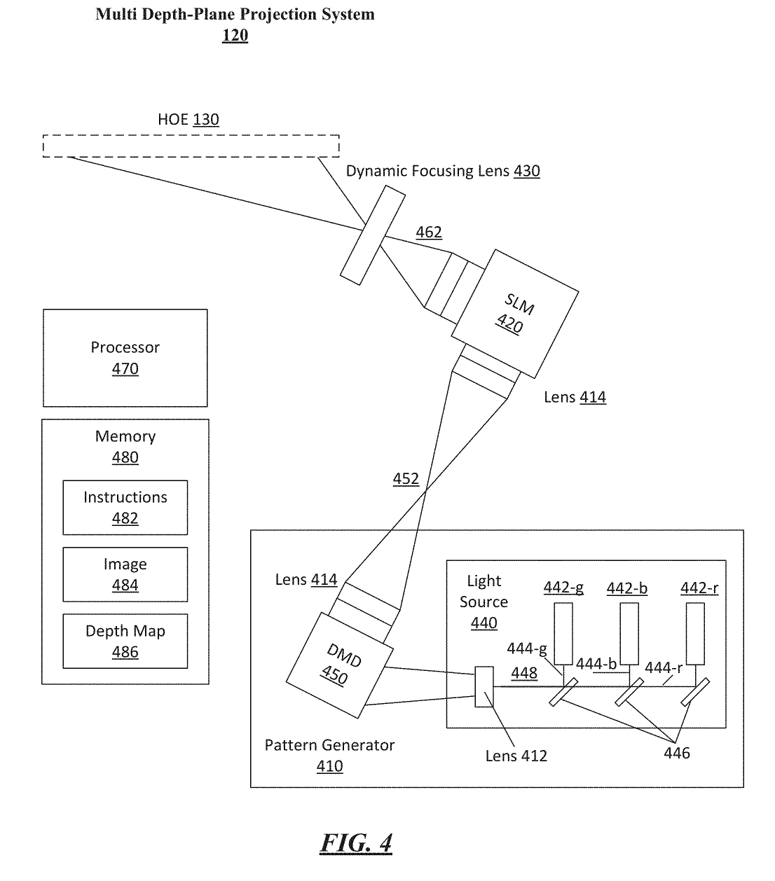

FIG. 4 illustrates another example multi depth-plane projection system 400, arranged according to some implementations. Multi depth-plane projection system 400 can be implemented as multi depth-plane projection system 120 of FIGS. 1 and 3. As depicted, multi depth-plane projection system 400 comprises a pattern generator 410 including a light source 440 and a digital micromirror device (DMD) 450. Multi-depth plane projector 400 can further include a processor 470 and memory 480 coupled to processor 470. Memory 480 can include instructions 482 executable by processor 470 and an image 484 and depth map 486.

Light source 440 can include multiple individual light sources 442 arranged to project individual light beams 444 that are combined with mirrors 446 to form composite light beam 448. For example, light source 440 can include a red light source 442-r emitting a red light beam 444-r, a green light source 442-g emitting a green light beam 444-g, and a blue light source 442-b emitting a blue light beam 444-b. Light beams 444-r, 444-g, and 444-b are combined with mirrors 446 to form composite light beam 448. Composite light beam 448 is collimated at lens 412 and relayed to DMD 450. DMD 450 is arranged to operate as a high-speed binary light modulator, which modulates light beam 448 to form selected patterns. DMD 450 emits modulated light 452. Modulated light 452 is transmitted through lenses 414. Lenses 414 can be arranged as a 4f lens system. Modulated light 452 is relayed to SLM 420, which is arranged as a low speed (relative to DMD 450) light modulator. With some examples, SLM 420 can be a liquid crystal display (LCD), a liquid crystal on silicon (LCoS) display, or the like. Modulated light 452 relayed through lenses 414 is again modulated by SLM 420 to selectively project portions of image 484 to form virtual images at different depth planes. SLM 420 emits light 462 corresponding to the virtual images at different depth planes, which is relayed dynamic lens 430 which focuses the virtual images of light 462 at the different depth planes and relays the focused light to HOE (e.g., HOE 135 of lens 130 of FIG. 2). Thus, a virtual image corresponding to the multiple partial images can be relayed to viewpoint and perceived in a vergence accommodation free manner by a user. This virtual image can be full color and have a wide field of view.

In general, dynamic lens 430 can be a liquid crystal (LC) based dynamic lens, a birefringence material based dynamic lens, or a liquid dynamic lens. Examples are not limited in this context. However, an example where dynamic lens 430 is a liquid dynamic lens is provided now. A change in the amount of liquid inside the aperture of dynamic lens 430 will lead to a change in the optical power of dynamic lens 430. Given the arrangement of HMD system 100, dynamic lens 430 is used as object lens in HMD system 100. Thus, a change of the optical power of dynamic lens 430 will change the distance at which virtual images are perceived or projected. Said differently, a change of the optical power of dynamic lens 430 will change the plane at which virtual images are focused or projected to.

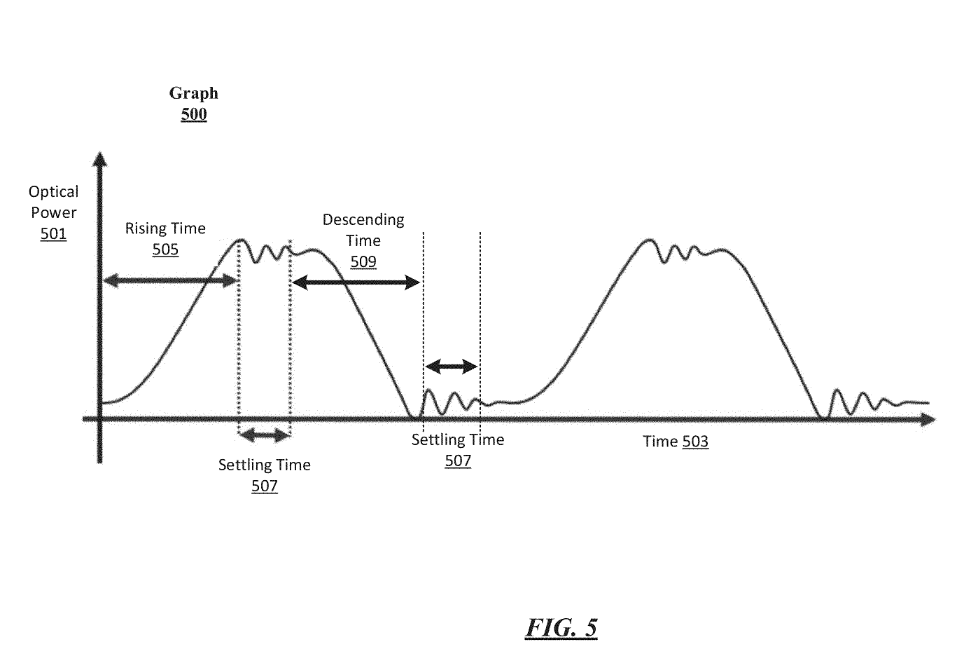

The switching of optical power of dynamic lens 430 is synchronized with the digital content projected by SLM 420 to create multiple virtual images projected at different planes. FIG. 5 depicts a graph 500 illustrating an optical power change response 510 of an example liquid dynamic lens. The response is depicted as optical power on the Y axis 501 and time on the X axis 503. As depicted, the response exhibits a rising time 505, settling time 507, and descending time 509. In practice, example liquid dynamic lenses may exhibit a rising time 505 and settling time 507 of between 2 milliseconds (ms) and 6 ms.

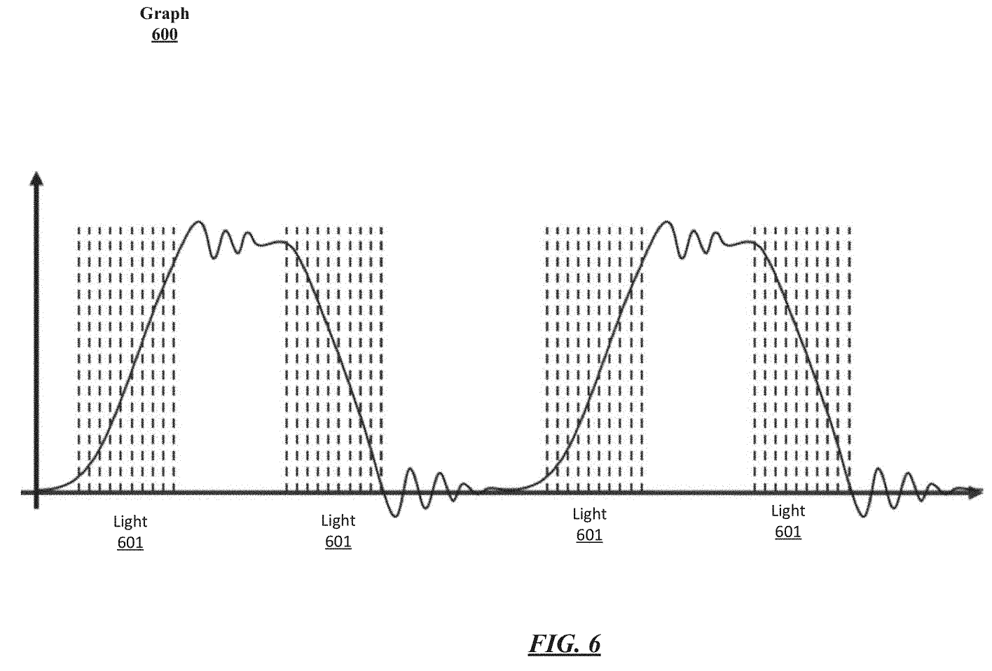

With some examples, virtual images projected by SLM 420 (e.g., light 462) can be relayed through dynamic lens 430 during the rising time 505 and descending time 509. Said differently, virtual images can be relayed through dynamic lens 430 in the time period of transition between two end points (e.g., between settling times 507. FIG. 6 depicts a graph 600 showing response 510 with light 601 corresponding to various virtual images inserted at time periods during the rising time 505 and the descending time 509. Thus, virtual images can be focused at different depth planes as the optical power of cycled.

With some examples, DMD 450 can be a conventional DMD including an array of micromirrors coupled to hinges. The micromirrors are addressable and can be controlled to be rotated (e.g., +/−15 degrees, or the like). At any given instance, each pixel on DMD 450 may be in one of two states, on or off. The DMD 450 can be driven by a pulse width modulation (PWM) to form gray scale patterns. By modulating the pixels of DMD 450 with different duty cycles, the pixels can have different intensities. For example, if a pixel is constantly on all the time, then it will have a high intensity level. However, if the pixel is on 50% of the time, it will have 50% of the highest intensity.

DMD 450 can be driven to display binary patterns at a high (relative to SLM 420) speed. For example, in some implementations, DMD 450 can display binary patterns at a frequency (or frame rate) of up to 32K frames per second. It is noted, that for grayscale images, the frame rate needs to be divided by 256. However, where DMD 450 is used as a backlight to modulate part of a static image formed on SLM 420 to from layers or slices of image 484, the slices can be formed at a frame rate significantly higher than the human eye can perceive. For example, DMD 450 selectively illuminates SLM 420 (e.g., DMD 450 is a backlight to an LCD or LCoS) to project layers of a virtual images, which are focused at different depth planes via dynamic lens 430

In general, a three-dimensional (3D) scene can be represented as a number of slices of image 484 and depth map 486. The 3D scene or image can be projected to a known viewing location by generating 2D images (e.g., selected portions of image 484) and projecting (or focusing) the 2D images to depth planes based on the depth map 486. Said differently, image 484 can be sliced into 2D images at depths based on the depth map 486 to form a 3D scene. Thus, DMD 450 generates backlight masks (e.g., light 452) based on depth map 486. The backlight masks selectively illuminate portions of the image statically formed by SLM 420 to project a number of different 2D images (e.g., slices of the 3D scene). These slices are then focused at different depth planes by dynamic lens 430.

Processor 470, in executing instructions 482 can cause SLM 420 to project image 484. Likewise, processor 470, in executing instructions 482, can synchronize DMD 450 with dynamic lens 430 to selectively illuminate portions of SLM 420 to project or focus the slices of image 484 formed by backlight masks at different depth planes based on depth map 486. In some examples, the backlight mask can be repeated (e.g., 3 times) where SLM 420 projects image in a color sequential manner (e.g., using LCoS, or the like).

With some examples, the processor 470 may include circuity or processor logic, such as, for example, any of a variety of commercial processors. In some examples, the processor 470 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 470 may include graphics processing portions and may include dedicated memory, multiple-threaded processing and/or some other parallel processing capability.

Memory 480 may include logic, a portion of which includes arrays of integrated circuits, forming non-volatile memory to persistently store data or a combination of non-volatile memory and volatile memory. It is to be appreciated, that the memory 480 may be based on any of a variety of technologies. In particular, the arrays of integrated circuits included in memory 480 may be arranged to form one or more types of memory, such as, for example, dynamic random access memory (DRAM), NAND memory, NOR memory, or the like.

FIG. 7 illustrates backlight masks 710 and corresponding virtual image slices 720. As described herein, backlight masks 710 can be formed by DMD 450 based on depth map 486. Backlight masks 710 can selectively illuminate portions of SLM 420 to form virtual image slices 720 of image 484. The virtual image slices 720 can be focused by dynamic lens 430 to form a 3D scene comprising the virtual image slices focused at different depth planes.

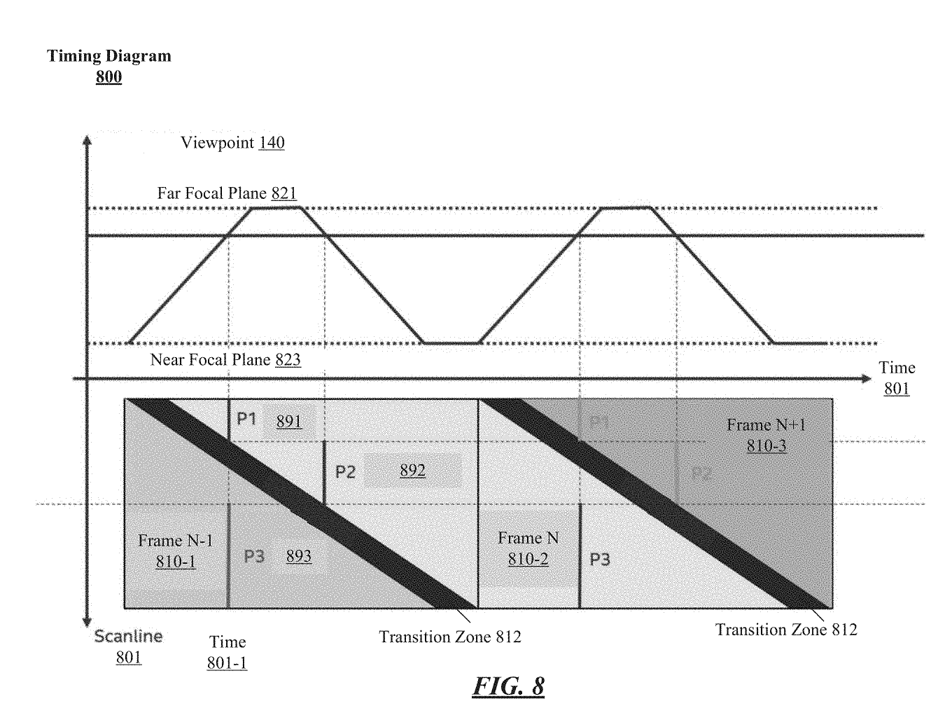

FIG. 8 illustrates an example timing diagram 800 for projecting a 3D scene to a viewpoint (e.g., viewpoint 140 of FIG. 1, or the like). It is noted, that SLM 420 (e.g., LCD, LCoS, etc.) may refresh in a rolling shutter fashion, which is line by line. Additionally, SLM 420 may have a fixed transitioning time for the SLM (e.g., LC cell, or the like) to transition to the new state. For example, timing diagram 800 depicts frames 810 projected with transition zones 812 between frames. Modulation of DMD 450 (e.g., generation of backlight masks, or the like) needs to be synchronized to avoid the transition zone 812 as well as to account for which frame or portion of frames is currently displayed.

Assume the backlight masks for each depth plane covers the entire image (e.g., as depicted in FIG. 7); an example of modulation of DMD 450, or backlight mask generation is described below. At any given time 801, SLM 420 may display portions of a frame 810 and a succeeding frame 810. For example, at time 801-1, SLM 420 could display portions of frame 810-1 (e.g., frame N-1 and frame 810-2 (e.g., frame N). Accordingly, a backlight mask 710 can be created for time period 801-1 that includes a mask corresponding to portions of the image for frame 810-1 and 810-2. Specifically, a backlight mask 710 can be created for portions of the image of frame 810-2 displayed on scanlines 803 corresponding to portion 891 (P1) and portion 892 (P2) as well as portions of the image of frame 810-1 displayed on scanlines 803 corresponding to portion 893 (P3).

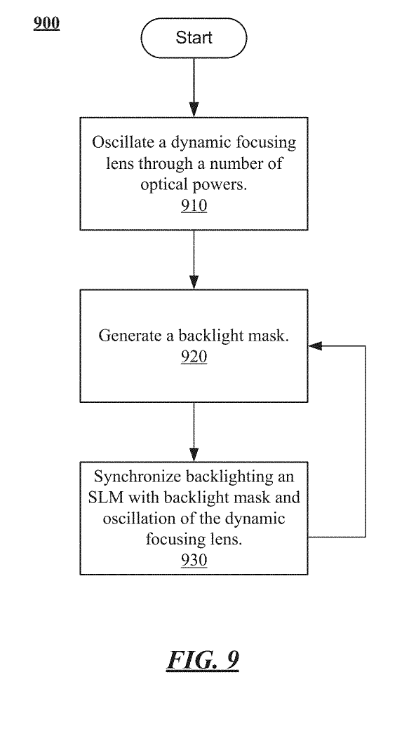

FIG. 9 illustrates a logic flow 900 for projecting a 3D image according to examples of the present disclosure. Logic flow 900 may begin at block 910. At block 910 “oscillate a dynamic focusing lens through a number of optical powers” a dynamic focusing lens can be oscillated through a number of optical powers. For example, dynamic focusing lens 430 can be oscillated through a number of optical powers (e.g., corresponding optical powers between far focal plane 821 and near focal plane 823). Continuing to block 920 “generate a backlight mask” a backlight mask can be generated. For example, light can be modulated by DMD 450 to generate backlight masks 710. Continuing to block 930 “synchronize backlighting of an SLM with oscillation of the dynamic focusing lens to selectively project an image slice at a depth plane” backlighting of SLM 420 with backlight mask 710 can be synchronized with the oscillation of dynamic focusing lens 430 to project image slices 720 at a particular depth plane based on depth map 486.

Logic flow 900 to repeat blocks 920 and 930 to repeatedly generate backlight masks 710 via DMD 450 and synchronize illumination of SLM 420 with oscillation of dynamic focusing lens 430 to generate additional image slices 720.

FIGS. 10A and 10B illustrate a system 1000 for recording an HOE in a lens and reconstructing the recorded HOE. Turning to FIG. 10A, the system 1000 is described with reference to the HOE 135 of lens 130 of FIG. 2. In general, the HOE 135 is a recorded hologram that performs some optical function, such as, lensing, mirroring, or the like. As noted above, HOE 135 is considered a diffractive optics, in that it is only active for light incident at certain direction and/or wavelengths. While, for other directions and/or wavelengths, the HOE 135 is transparent or substantially transparent. As such, HOE 135 can be used as a combiner to increase the FOV and/or provide an AR display.

As depicted in this figure, system 1000 provides a reference beam 1010 and an object beam 1020. Often, the reference beam 1010 and/or the object beam are fixed in plane. The reference beam 1010 and object beam 1020 are arranged to interfere with each other to record the hologram in a photopolymer material 1030 to form the HOE 135. In some implementations, the object beam 1020 can be transmitted through a lens 1040 to focus the object beam at the photopolymer material 1030. In some examples, lens 1040 can operate as a combiner reflector to increase the FOV of the HOE 135 resulting from interfering the reference beam 1010 and object beam 1020 at the photopolymer material 1030.

Turning to FIG. 10B, the recorded hologram (e.g., HOE 135) can be used to reconstruct or recreate the object beam 1020. For example, incidence of the reference beam 1010 on the HOE 135 will result in reconstruction of the object beam 1020. This reconstructed object beam could be used to manufacture additional HOEs (e.g., as in FIG. 10A) with a master HOE 135 and the reference beam 1010.

FIG. 11 illustrates an embodiment of a storage medium 2000. The storage medium 2000 may comprise an article of manufacture. In some examples, the storage medium 2000 may include any non-transitory computer readable medium or machine readable medium, such as an optical, magnetic or semiconductor storage. The storage medium 2000 may store various types of computer executable instructions e.g., 2002). For example, the storage medium 2000 may store various types of computer executable instructions to implement technique 900.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

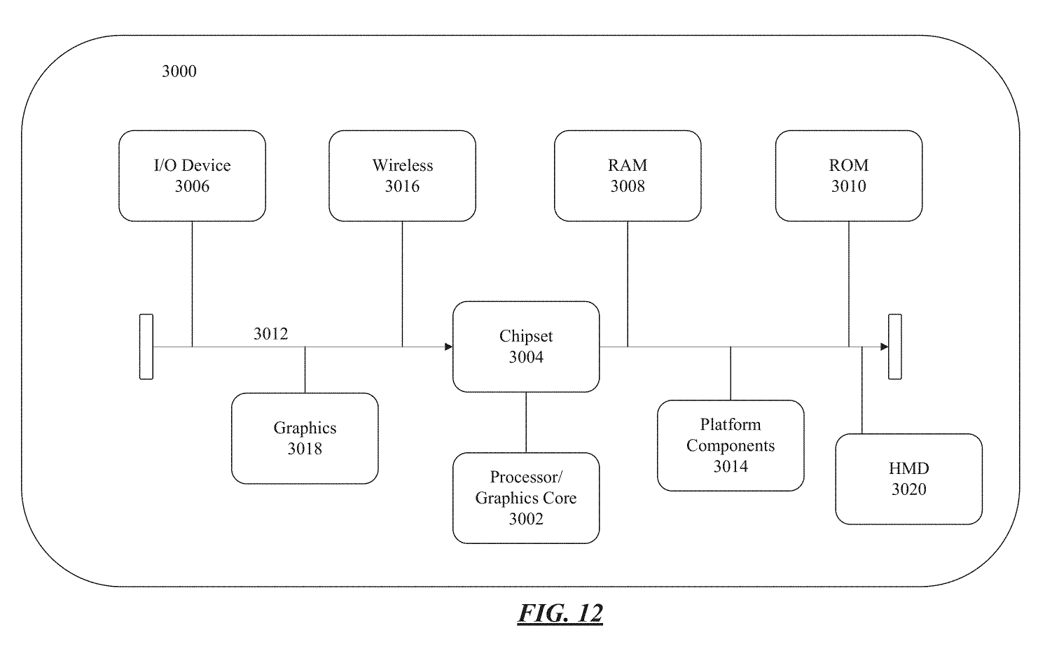

FIG. 12 is a diagram of an exemplary system embodiment and in particular, depicts a platform 3000, which may include various elements. For instance, this figure depicts that platform (system) 3000 may include a processor/graphics core 3002, a chipset/platform control hub (PCH) 3004, an input/output (I/O) device 3006, a random access memory (RAM) (such as dynamic RAM (DRAM)) 3008, and a read only memory (ROM) 3010, HMD 3020 (e.g., HMD system 100, multi depth-plane projection system 120 and lens 130, or the like), and various other platform components 3014 (e.g., a fan, a cross flow blower, a heat sink, DTM system, cooling system, housing, vents, and so forth). System 3000 may also include wireless communications chip 3016 and graphics device 3018. The embodiments, however, are not limited to these elements.

As depicted, I/O device 3006, RAM 3008, and ROM 3010 are coupled to processor 3002 by way of chipset 3004. Chipset 3004 may be coupled to processor 3002 by a bus 3012. Accordingly, bus 3012 may include multiple lines.

Processor 3002 may be a central processing unit comprising one or more processor cores and may include any number of processors having any number of processor cores. The processor 3002 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 3002 may be multiple separate processors located on separate integrated circuit chips. In some embodiments processor 3002 may be a processor having integrated graphics, while in other embodiments processor 3002 may be a graphics core or cores.

The following examples pertain to further embodiments, from which numerous permutations and configurations will be apparent.

Example 1. A head mounted display (HMD) system, comprising: a frame arranged to be worn on a human head; a multi depth-plane projection system coupled to the frame, the multi depth-plane projection system comprising: a pattern generator to generate a plurality of backlight masks; a spatial light modulator (SLM) arranged to project a plurality of image slices based on the plurality of backlight masks; and a dynamic focusing lens to focus the plurality of image slices at different depth planes; and a lens coupled to the frame and in optical communication with the multi-depth projection system, the lens to reflect the plurality of image slices focused at the different depth planes to a viewpoint.

Example 2. The HMD system of example 1, the lens comprising a holographic optical element (HOE) arranged to receive the plurality of image slices focused at the different depth planes and reflect the plurality of image slices focused at the different depth planes to the viewpoint.

Example 3. The HMD of example 2, the HOE further arranged to transmit light corresponding to the real world to the viewpoint to provide an augmented reality display.

Example 4. The HMD system of example 1, the pattern generator comprising: a light source to emit a light beam; and a digital micromirror device (DMD) to receive the light beam and modulate the light beam to form the plurality of backlight masks.

Example 5. The HMD system of example 4, wherein the plurality of backlight masks are binary.

Example 6. The HMD system of example 1, wherein the SLM is a liquid crystal display or a liquid crystal on silicon display.

Example 7. The HMD system of example 1, comprising: a processor; and a memory coupled to the processor, the memory comprising instructions executable by the processor, the instructions when executed by the processor cause the processor to: send a control signal to cause the dynamic focusing lens to oscillate through a plurality of optical powers; and synchronize generation of the plurality of backlight masks and plurality of image slices with the oscillation of the dynamic focusing lens to focus the plurality of image slices at selected depth planes.

Example 8. The HMD system of example 7, the memory comprising instructions, which when executed by the processor cause the processor to synchronize generation of the plurality of backlight masks and plurality of image slices with the periods of oscillation of the dynamic focusing lens corresponding to rising time and descending time of a response of the dynamic focusing lens to the oscillation.

Example 9. The HMD system of example 8, wherein the SLM updates a plurality of pixels in a rolling pattern, the memory comprising instructions, which when executed by the processor cause the processor to synchronize generation of the plurality of backlight masks based on the rolling pattern, wherein a one of the plurality of backlight masks corresponds to a first frame of the plurality of images and a second, subsequent, frame of the plurality of images.

Example 10. A multi depth-plane projector, comprising: a pattern generator to generate a plurality of backlight masks; a spatial light modulator (SLM) arranged to project a plurality of image slices based on the plurality of backlight masks; and a dynamic focusing lens to focus the plurality of image slices at different depth planes.

Example 11. The multi depth-plane projector of example 10, the pattern generator comprising: a light source to emit a light beam; and a digital micromirror device (DMD) to receive the light beam and modulate the light beam to form the plurality of backlight masks.

Example 12. The multi depth-plane projector of example 11, wherein the plurality of backlight masks are binary.

Example 13. The multi depth-plane projector of example 10, wherein the SLM is a liquid crystal display or a liquid crystal on silicon display.

Example 14. The multi depth-plane projector of example 10, comprising: a processor; and a memory coupled to the processor, the memory comprising instructions executable by the processor, the instructions when executed by the processor cause the processor to: send a control signal to cause the dynamic focusing lens to oscillate through a plurality of optical powers; and synchronize generation of the plurality of backlight masks and plurality of image slices with the oscillation of the dynamic focusing lens to focus the plurality of image slices at selected depth planes.

Example 15. The multi depth-plane projector of example 14, the memory comprising instructions, which when executed by the processor cause the processor to synchronize generation of the plurality of backlight masks and plurality of image slices with the periods of oscillation of the dynamic focusing lens corresponding to rising time and descending time of a response of the dynamic focusing lens to the oscillation.

Example 16. At least one machine-readable storage medium comprising instructions that when executed by a processor at a platform coupled to a panel via a display interconnect, cause the processor to: send a control signal to a pattern generator to cause the pattern generator to generate a plurality of backlight masks; send a control signal to a spatial light modulator (SLM) to project a plurality of image slices based on the plurality of backlight masks and an image; and send a control signal to a dynamic focusing lens to cause the dynamic focusing lens to focus the plurality of image slices at different depth planes.

Example 17. The at least one machine-readable storage medium of example 16, the pattern generator comprising a light source and a digital micromirror device (DMD), the medium comprising instructions that further cause the processor to send a control signal to a light source to cause the light source to emit a light beam to illuminate the DMD to generate the plurality of backlight masks.

Example 18. The at least one machine-readable storage medium of example 16, wherein the plurality of backlight masks are binary.

Example 19. The at least one machine-readable storage medium of example 16, wherein the SLM is a liquid crystal display or a liquid crystal on silicon display.

Example 20. The at least one machine-readable storage medium of example 16, comprising instructions that further cause the processor to synchronize generation of the plurality of backlight masks and plurality of image slices with the oscillation of the dynamic focusing lens to focus the plurality of image slices at selected depth planes.

Example 21. The at least one machine-readable storage medium of example 20, comprising instructions that further cause the processor to synchronize generation of the plurality of backlight masks and plurality of image slices with the periods of oscillation of the dynamic focusing lens corresponding to rising time and descending time of a response of the dynamic focusing lens to the oscillation.

Example 22. A method, comprising: generating, via a pattern generator, a plurality of backlight masks; projecting a plurality of image slices, via a spatial light modulator (SLM), based in part on backlighting the SLM with the plurality of backlight masks; and focusing, via a dynamic focusing lens, the plurality of image slices at different depth planes.

Example 23. The method of example 22, comprising directing, via a light source, a light beam to illuminate a digital micromirror device (DMD) to generate the plurality of backlight masks.

Example 24. The method of example 22, wherein the plurality of backlight masks are binary.

Example 25. The method of example 22, wherein the SLM is a liquid crystal display or a liquid crystal on silicon display.

Example 26. The method of example 22, comprising synchronizing generation of the plurality of backlight masks and plurality of image slices with the oscillation of the dynamic focusing lens to focus the plurality of image slices at selected depth planes.

Example 27. The method of example 26, comprising synchronizing generation of the plurality of backlight masks and plurality of image slices with the periods of oscillation of the dynamic focusing lens corresponding to rising time and descending time of a response of the dynamic focusing lens to the oscillation.

Example 28. The method of example 27, wherein the SLM updates a plurality of pixels in a rolling pattern, the method comprising synchronizing generation of the plurality of backlight masks based on the rolling pattern, wherein a one of the plurality of backlight masks corresponds to a first frame of the plurality of images and a second, subsequent, frame of the plurality of images.

Example 29. An apparatus, comprising means arranged to implement the function of any one of examples 22 to 28.

Example 30. At least one non-transitory computer-readable storage medium comprising instructions that when executed by a computing device, cause the computing device to perform the method of any one of examples 22 to 28.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A head mounted display (HMD) system, comprising:
a frame arranged to be worn on a human head;
a multi depth-plane projection system coupled to the frame, the multi depth-plane projection system comprising:
a pattern generator to generate a plurality of backlight masks;
a spatial light modulator (SLM) arranged to project a plurality of image slices based on the plurality of backlight masks; and
a dynamic focusing lens to focus the plurality of image slices at different depth planes; and
a lens coupled to the frame and in optical communication with the multi-depth projection system, the lens to reflect the plurality of image slices focused at the different depth planes to a viewpoint.

2. The HMD system of claim 1, the lens comprising a holographic optical element (HOE) arranged to receive the plurality of image slices focused at the different depth planes and reflect the plurality of image slices focused at the different depth planes to the viewpoint.

3. The HMD of claim 2, the HOE further arranged to transmit light corresponding to the real world to the viewpoint to provide an augmented reality display.

4. The HMD system of claim 1, the pattern generator comprising:
a light source to emit a light beam; and
a digital micromirror device (DMD) to receive the light beam and modulate the light beam to form the plurality of backlight masks.

5. The HMD system of claim 4, wherein the plurality of backlight masks are binary.

6. The HMD system of claim 1, wherein the SLM is a liquid crystal display or a liquid crystal on silicon display.

7. The HMD system of claim 1, comprising:
a processor; and
a memory coupled to the processor, the memory comprising instructions executable by the processor, the instructions when executed by the processor cause the processor to:
send a control signal to cause the dynamic focusing lens to oscillate through a plurality of optical powers; and
synchronize generation of the plurality of backlight masks and plurality of image slices with the oscillation of the dynamic focusing lens to focus the plurality of image slices at selected depth planes.

8. The HMD system of claim 7, the memory comprising instructions, which when executed by the processor cause the processor to synchronize generation of the plurality of backlight masks and plurality of image slices with the periods of oscillation of the dynamic focusing lens corresponding to rising time and descending time of a response of the dynamic focusing lens to the oscillation.

9. The HMD system of claim 8, wherein the SLM updates a plurality of pixels in a rolling pattern, the memory comprising instructions, which when executed by the processor cause the processor to synchronize generation of the plurality of backlight masks based on the rolling pattern, wherein a one of the plurality of backlight masks corresponds to a first frame of the plurality of images and a second, subsequent, frame of the plurality of images.

10. A multi depth-plane projector, comprising:
a pattern generator to generate a plurality of backlight masks;
a spatial light modulator (SLM) arranged to project a plurality of image slices based on the plurality of backlight masks; and
a dynamic focusing lens to focus the plurality of image slices at different depth planes.

11. The multi depth-plane projector of claim 10, the pattern generator comprising:
a light source to emit a light beam; and
a digital micromirror device (DMD) to receive the light beam and modulate the light beam to form the plurality of backlight masks.

12. The multi depth-plane projector of claim 11, wherein the plurality of backlight masks are binary.

13. The multi depth-plane projector of claim 10, wherein the SLM is a liquid crystal display or a liquid crystal on silicon display.

14. The multi depth-plane projector of claim 10, comprising:
a processor; and
a memory coupled to the processor, the memory comprising instructions executable by the processor, the instructions when executed by the processor cause the processor to:
send a control signal to cause the dynamic focusing lens to oscillate through a plurality of optical powers; and
synchronize generation of the plurality of backlight masks and plurality of image slices with the oscillation of the dynamic focusing lens to focus the plurality of image slices at selected depth planes.

15. The multi depth-plane projector of claim 14, the memory comprising instructions, which when executed by the processor cause the processor to synchronize generation of the plurality of backlight masks and plurality of image slices with the periods of oscillation of the dynamic focusing lens corresponding to rising time and descending time of a response of the dynamic focusing lens to the oscillation.

16. At least one machine-readable storage medium comprising instructions that when executed by a processor at a platform coupled to a panel via a display interconnect, cause the processor to:
send a control signal to a pattern generator to cause the pattern generator to generate a plurality of backlight masks;
send a control signal to a spatial light modulator (SLM) to project a plurality of image slices based on the plurality of backlight masks and an image; and
send a control signal to a dynamic focusing lens to cause the dynamic focusing lens to focus the plurality of image slices at different depth planes.

17. The at least one machine-readable storage medium of claim 16, the pattern generator comprising a light source and a digital micromirror device (DMD), the medium comprising instructions that further cause the processor to send a control signal to a light source to cause the light source to emit a light beam to illuminate the DMD to generate the plurality of backlight masks.

18. The at least one machine-readable storage medium of claim 16, wherein the plurality of backlight masks are binary.

19. The at least one machine-readable storage medium of claim 16, wherein the SLM is a liquid crystal display or a liquid crystal on silicon display.

20. The at least one machine-readable storage medium of claim 16, comprising instructions that further cause the processor to synchronize generation of the plurality of backlight masks and plurality of image slices with the oscillation of the dynamic focusing lens to focus the plurality of image slices at selected depth planes.

21. The at least one machine-readable storage medium of claim 20, comprising instructions that further cause the processor to synchronize generation of the plurality of backlight masks and plurality of image slices with the periods of oscillation of the dynamic focusing lens corresponding to rising time and descending time of a response of the dynamic focusing lens to the oscillation.
